(19) United States
(12) Patent Application Publication
(10) Pub. No.: US 2011/0260933 A1
(43) Pub. Date: Oct. 27, 2011

(54) MOBILE RADIO APPARATUS

(75) Inventors: Tsukasa Takahashi, Kanagawa (JP); Haruhiko Kakitsu, Shizuoka (JP)

(73) Assignee: PANASONIC CORPORATION, Osaka (JP)

(21) Appl. No.: 13/142,208

(22) PCT Filed: Jun. 23, 2009
(86) PCT No.: PCT/JP2009/002875

§ 371 Date: Jun. 24, 2011

(30) Foreign Application Priority Data
Dec. 25, 2008 (JP) 2008-329979

(51) Int. Cl. H01Q 1/24

(52) U.S. Cl. 343/702

(57) ABSTRACT

A mobile radio apparatus that can prevent degradation of the antenna characteristic if three or more antenna elements are included is provided.

A mobile radio apparatus includes a housing; a circuit board 20 provided in the housing; and a first antenna 11, a second antenna 12, and a third antenna 13 placed in one end in the housing and operating in different operation frequency bands. The first antenna 11 operates in a first operation frequency band, the second antenna 12 operates in a second frequency band close to the first operation frequency band, and the third antenna 13 operates in a third operation frequency band not close to the first operation frequency band or the second operation frequency band and is placed between the first antenna 11 and the second antenna 12 in the one end in the housing.

### TECHNICAL FIELD

This invention relates to a mobile radio apparatus including a plurality of antenna elements.

### BACKGROUND ART

In recent years, various applications such as a communication application, digital TV application, and GPS (Global Positioning System) have been installed in one mobile telephone terminal. To execute the applications, the antennas each for each application may become necessary. If a mobile telephone terminal includes different antennas each for each application, namely, a plurality of antennas, it is necessary to devise the mobile telephone terminal so that electromagnetic coupling does not occur between the antennas.

As an art to prevent electromagnetic coupling from occurring between the antennas, an art wherein a foldable housing is provided and one of antennas is placed in a hinge part of the housing and another antenna is placed at an opposite position to the hinge part of the housing for enlarging the distance between the antennas (for example, refer to Patent Document 1).

### RELATED ART DOCUMENTS

### Patent Documents

Patent Document 1: Japanese Patent Laid-Open No. 2004-153589

### SUMMARY OF THE INVENTION

Problems to be Solved by the Invention

On the other hand, in recent years, miniaturization of a mobile telephone terminal has advanced more and more. If the mobile telephone terminal is very small, it is difficult to suppress occurrence of electromagnetic coupling between the antennas using the art in Patent Document 1. Particularly, if three or more antenna elements are installed on one housing, the distance between at least two antenna elements of three antenna elements becomes inevitably close, electromagnetic coupling occurs, and the possibility of degradation of the antenna characteristic becomes high. Further, if the mobile telephone terminal is very small, as shown in FIG. 5, the user grasps the mobile telephone terminal, whereby one of a plurality of antennas 101 to 103 (for example, antenna 103) is covered with a hand and the possibility of degradation of the antenna characteristic becomes high.

In view of the circumstances described above, it is an object of the invention to provide a mobile radio apparatus that can prevent degradation of the antenna characteristic if three or more antenna elements are included.

### Means for Solving the Problems

A mobile radio apparatus of the invention is a mobile radio apparatus including a housing; a circuit board provided in the housing; and a first antenna element, a second antenna element, and a third antenna element placed in one end in the housing and operating in different operation frequency bands, wherein the first antenna element operates in a first operation frequency band, wherein the second antenna element operates in a second frequency band close to the first operation frequency band, and wherein the third antenna element operates in a third operation frequency band not close to the first operation frequency band or the second operation frequency band and is placed between the first antenna element and the second antenna element in the one end in the housing.

According to the configuration, if three or more antenna elements are included, degradation of the antenna characteristic can be prevented.

In the mobile radio apparatus of the invention, when two operation frequency bands are close to each other, the ratio of the difference between the lowest frequency in the higher band of the two operation frequency bands and the highest frequency in the lower band of the two operation frequency bands to the lowest frequency in the higher band of the two operation frequency bands is equal to or less than 0.2.

According to the configuration, the ratio is set to 0.2 or more about the adjacently placed antenna elements, whereby degradation of the antenna characteristic caused by electromagnetic coupling can be prevented appropriately.

In the mobile radio apparatus of the invention, the distance between the one end and a third feeding section for feeding power to the third antenna is longer than the distance between the one end and a first feeding section for feeding power to the first antenna and is longer than the distance between the one end and a second feeding section for feeding power to the second antenna.

According to the configuration, usually, for example, the first antenna element close to one end in the width direction (for example, upper left end part of the housing) in one end in the length direction of the housing of the mobile radio apparatus and the second antenna element close to an opposite end in the width direction (for example, upper right end part of the housing) in the one end in the length direction of the housing has better antenna efficiency than the third antenna element distant from the end parts (upper left end part and upper right end part). However, the distance between the one end in the length direction of the housing (upper end) and the feeding section is also made long about third antenna, whereby antenna efficiency can be improved, so that the antenna efficiency can be kept uniform in every antenna element.

The mobile radio apparatus of the invention includes a fourth antenna element placed in the one end in the housing and operating in a different operation frequency band from those of the first antenna element, the second antenna element, and the third antenna element, wherein the fourth antenna element operates in a fourth operation frequency band close to the third operation frequency band and not close to the first operation frequency band or the second operation frequency band and is placed on the opposite side to the third antenna element relative to the second antenna element or on the opposite side to the third antenna element relative to the first antenna element in the one end in the housing.

According to the configuration, if four antenna elements are included, the antenna elements having operation frequency bands not close to each other are placed adjacently, whereby degradation of the antenna characteristic can be prevented.

### Advantages of the Invention

According to the invention, if three or more antenna elements are included, degradation of the antenna characteristic can be prevented.

### BRIEF DESCRIPTION OF THE DRAWINGS

FIG. 1 is a block diagram to show a configuration example of a mobile radio apparatus in a first embodiment of the invention.

FIG. 2 is a drawing to show an example of the relationship among operation frequency bands in which antennas operate in the first embodiment of the invention.

FIG. 3 is a block diagram to show a configuration example of a mobile radio apparatus in a second embodiment of the invention.

FIG. 4 is a block diagram to show a configuration example of a mobile radio apparatus in a third embodiment of the invention.

FIG. 5 is a block diagram to show a configuration example of a conventional mobile radio apparatus.

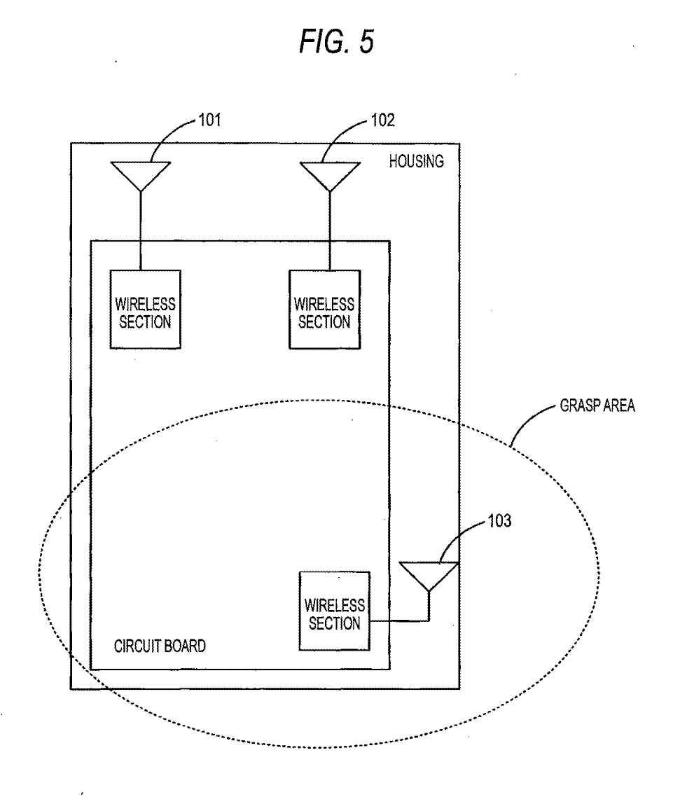

### MODE FOR CARRYING OUT THE INVENTION

Mobile radio apparatuss of embodiments of the invention will be discussed below in detail with reference to the accompanying drawings:

### First Embodiment

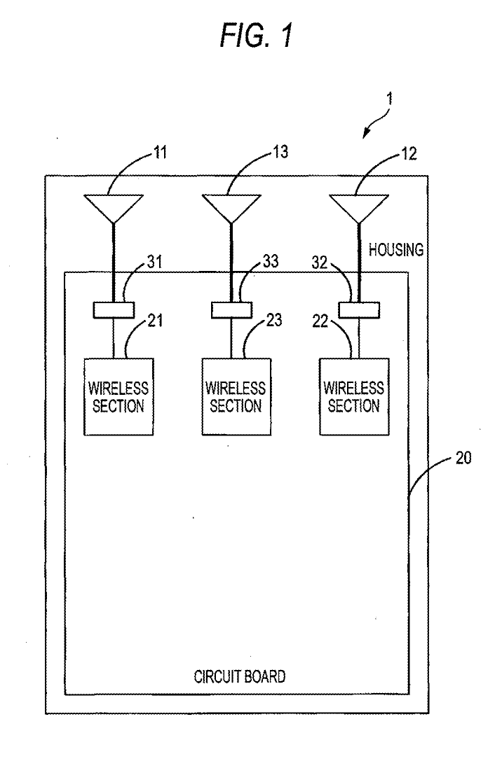

FIG. 1 is a block diagram to show a configuration example of a mobile radio apparatus in a first embodiment of the invention. A mobile radio apparatus 1 shown in FIG. 1 is made up of a first antenna 11, a second antenna 12, a third antenna 13, and a circuit board 20. The circuit board 20 is made up of a first wireless section 21, a second wireless section 22, a third wireless section 23, a first feeding section 31, a second feeding section 32, and a third feeding section 33.

A mobile telephone terminal, etc., is considered as the mobile radio apparatus 1. As the mobile telephone terminal, a slide-type mobile telephone terminal having two housings, a fold-type mobile telephone terminal having two housings, a straight-type mobile telephone terminal having one housing, and the like are considered.

The first antenna 11 is incorporated in a housing of the mobile radio apparatus 1 and is electrically connected to the first wireless section 21. For example, the first antenna 11 is used to receive a digital television (DTV) broadcast wave and the operation frequency band is 470 MHz to 770 MHz.

The second antenna 12 is incorporated in the housing of the mobile radio apparatus 1 and is electrically connected to the second wireless section 22. For example, the second antenna 12 is used to transmit and receive a cellular radio wave and the operation frequency band is 830 MHz to 885 MHz.

The second antenna 13 is incorporated in the housing of the mobile radio apparatus 1 and is electrically connected to the third wireless section 23. For example, the third antenna 13 is used to receive a radio wave containing position information based on a GPS function and the operation frequency band is 1575 MHz.

The antennas 11 to 13 are antenna elements as a dipole antenna and a monopole antenna, for example. The antennas 11 to 13 operate in different operation frequency bands. It is assumed that the antennas are used for DTV broadcast, cellular radio wave, and GPS by way of example; the antennas may be antennas for realizing other applications. Therefore, the first operation frequency band in which the first antenna 11 operates, the second operation frequency band in which the second antenna 12 operates, and the third operation frequency band in which the third antenna 13 operates may be other operation frequency bands than those described above if a predetermined condition is satisfied. In the example shown in FIG. 1, the antenna shape is straight type, but may be any other shape such as letter L.

The first wireless section 21 performs necessary processing such as predetermined reception processing for a DTV broadcast signal from the first antenna 11, thereby implementing a DTV reception function. The operation frequency is the same as that of the first antenna 11.

The second wireless section 22 performs necessary processing such as predetermined transmission and reception processing for a cellular wireless communication signal transmitted and received using the second antenna 12, thereby implementing a cellular wireless communication function. The operation frequency is the same as that of the second antenna 12.

The third wireless section 23 performs necessary processing such as predetermined reception processing for a GPS wireless signal from the third antenna 13, thereby implementing a GPS function. The operation frequency is the same as that of the third antenna 13.

Here, it is assumed that the wireless sections 21 to 23 perform necessary processing for DTV broadcast, cellular radio wave, and GPS by way of example; the wireless sections 21 to 23 perform necessary processing of reception processing, etc., conforming to the signals received or transmitted by the corresponding antennas 11 to 13.

The first feeding section 31 is electrically connected to the first antenna 11 and the first wireless section 21 and feeds power mainly to the first antenna 11. The second feeding section 32 is electrically connected to the second antenna 12 and the second wireless section 22 and feeds power mainly to the second antenna 12. The third feeding section 33 is electrically connected to the third antenna 13 and the third wireless section 23 and feeds power mainly to the third antenna 13.

In the example shown in FIG. 1, the first feeding section 31 is placed in one end in the width direction in one end in the length direction of the circuit board 20 (here, upper left end part), the second feeding section 32 is placed in an opposite end in the width direction in one end in the length direction of the circuit board 20 (here, upper right end part), and the third feeding section 33 is placed in the center in the width direction in one end in the length direction of the circuit board 20 (here, upper end center).

Next, the placement relationship among the antennas 11 to 13 will be discussed.

The antennas 11 to 13 are placed in the same one end in the housing of the mobile radio apparatus 1. In the example shown in FIG. 1, they are placed in the upper end of the housing of the mobile radio apparatus 1. However, the placement is not limited to the example shown in FIG. 1; the one end may be one end in the length direction of the housing (upper end or lower end) or may be one end in the width direction of the housing (left end or right end). It is assumed that the one end has a measure of a width where the antennas can be placed. Thus, the antennas 11 to 13 are concentrically placed in the same one end, whereby if the user grasps the mobile radio apparatus 1, the antennas 11 to 13 are not covered with a hand and degradation of the antenna characteristic can be prevented.

In the mobile radio apparatus 1, the first antenna 11 is placed in one end in one end (in the example shown in FIG. 1, one end in the width direction in one end in the length direction of the housing), the second antenna 12 is placed in an opposite end in one end (in the example shown in FIG. 1, opposite end in the width direction in one end in the length direction of the housing), and the third antenna 13 is placed in the center in one end (in the example shown in FIG. 1, center in the width direction in one end in the length direction of the housing). That is, in the example shown in FIG. 1, the first antenna 11 is placed in the upper left end part, the second antenna 12 is placed in the upper right end part, and the third antenna 13 is placed in the upper end center.

Next, the operation frequency bands of the antennas 11 to 13 will be discussed.

The embodiment assumes the following state for the operation frequency bands in which the antennas 11 to 13 operate:
The first operation frequency band in which the first antenna 11 operates is close to the second operation frequency band in which the second antenna 12 operates.
The second operation frequency band in which the second antenna 12 operates is not close to the third operation frequency band in which the third antenna 13 operates.
The third operation frequency band in which the third antenna 13 operates is not close to the first operation frequency band in which the first antenna 11 operates.

The close state is the state in which two operation frequency bands are close to each other, and indicates the state in which the ratio of the difference between the lowest frequency in the higher band of the two operation frequency bands and the highest frequency in the lower band of the two operation frequency bands to the lowest frequency in the higher band of the two operation frequency bands is equal to or less than about 0.2. That is, when the width of closest frequencies in the two operation frequency bands is within about 20% as the frequency ratio, the state is the state in which the two operation frequency bands are close to each other.

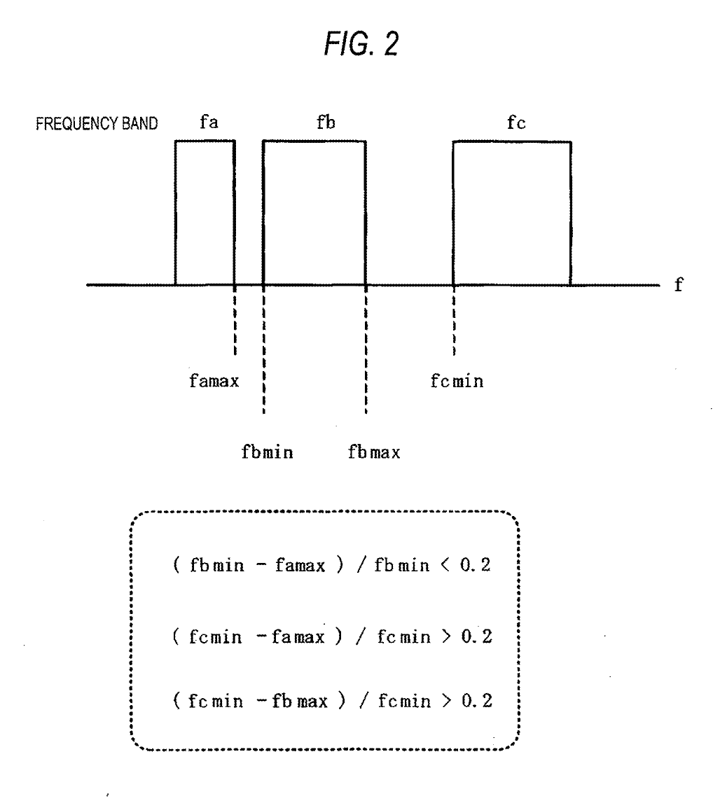

Therefore, letting the first operation frequency band be fa, the second operation frequency band be fb, and the third operation frequency band be fc as shown in FIG. 2, the following (expression 1) to (expression 3) are satisfied where fa<fb<fc:

(fbmin−famax)/fbmin<0.2 (expression 1)

(fcmin−famax)/fcmin>0.2 (expression 2)

(fcmin−fbmax)/fcmin>0.2 (expression 3)

max indicates the highest frequency in the frequency band and min indicates the lowest frequency in the frequency band.

For example, when the first antenna 11 functions as a DTV antenna, the second antenna 12 functions as a cellular antenna, and the third antenna 13 functions as a GPS antenna, if the operation frequencies are applied to (expression 1) to (expression 3), the following results:
For (expression 1) (830-770)/830 is near equal to 0.07
For (expression 2) (1575-770)/1575 is near equal to 0.51
For (expression 3) (1575-885)/1575 is near equal to 0.44

Therefore, if the antennas 11 to 13 are arranged in one end as in the example, the operation frequency band of the first antenna 11 is close to the operation frequency band of the second antenna 12, the operation frequency band of the second antenna 12 is not close to the operation frequency band of the third antenna 13, and the operation frequency band of the third antenna 13 is not close to the operation frequency band of the first antenna 11.

According to the mobile radio apparatus 1 of the embodiment, when three or more antennas are arranged in one end, the third antenna 13 whose operation frequency band is not close to the operation frequency bands of the first antenna 11 and the second antenna 12 placed in both ends in one end is placed in the center of the one end and the first antenna 11 and the third antenna and the second antenna and the third antenna placed adjacent in the one end operate in operation frequency bands not close to each other, so that electromagnetic coupling does not occur between the adjacent antennas. Therefore, if three or more antenna elements are included, degradation of the antenna characteristic can be prevented.

When the first antenna 11 functions as a DTV antenna and the second antenna 12 functions as cellular antenna, if the operation frequency band fc of the third antenna 13 is a higher frequency band of the second antenna 12 and is not close to the operation frequency band of the second antenna 12, the following expression is satisfied:

(fcmin−885)/fcmin>0.2

In this case, fcmin>1106 (MHz). Therefore, if the third antenna is applied to a WLAN (2.4 GHz) or Bluetooth (2.4 GHz) antenna in addition to use as the GPS antenna, communications can be conducted without generating degradation of the antenna characteristic caused by electromagnetic coupling.

In the embodiment, the number of antennas is three, but may be four or more. An example wherein the number of antennas is four is shown in a third embodiment described later.

### Second Embodiment

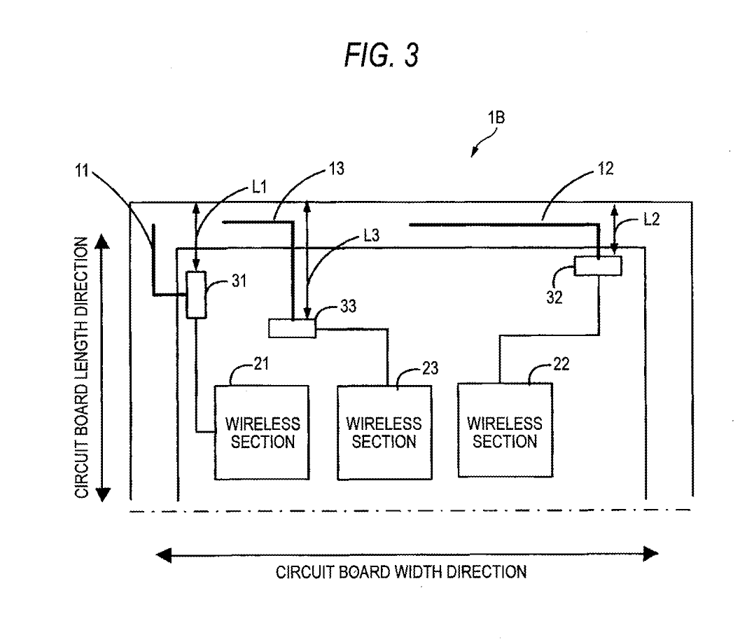

FIG. 3 is a block diagram to show a configuration example of a mobile radio apparatus in a second embodiment of the invention. FIG. 3 shows a part of the mobile radio apparatus. Components of a mobile radio apparatus 1B identical with those of the mobile radio apparatus 1 are denoted by the same reference numerals and will not be discussed again or will be discussed briefly.

The mobile radio apparatus 1 of the first embodiment described above and the mobile radio apparatus 1B of the second embodiment differ in that a third feeding section 33 is placed in an inner side of a circuit board 20 as compared with a first feeding section 31 and a second feeding section 32.

Each of antennas 11 to 13 is bent like letter L as shown in FIG. 3. As for the length in the circuit board length direction, of the letter L shape of a part of each of the antennas 11 to 13, the length of the third antenna 13 in the circuit board length direction is longer than the length of the first antenna 11 and the length of the second antenna 12 in the circuit board length direction. This means that distance L3 between the upper end of a housing of the mobile radio apparatus 1B and the third feed section 33 is longer than distance L1 between the upper end and the first feeding section 31 and is longer than distance L2 between the upper end and the second feeding section 32.

The first feeding section 31 and the second feeding section 32 are placed in end parts of the circuit board 20 although the distances L1 and L2 are short. Thus, degradation of the antenna characteristic is small. On the other hand, the third feed section 33 is at some distance from the end part of the circuit board 20 and thus if the distance L3 and the distances L1 and L2 are the same, the antenna characteristic of the third antenna 13 is degraded as compared with the first antenna 11 and the second antenna 12. However, in the configuration in FIG. 3, L3 is longer than L1 and L2 and thus the third antenna 13 easily receives polarization in the length direction and thus the antenna gain can be enhanced and the characteristic of each antenna can be maintained equal. Particularly, the space where the third antenna 13 can be placed in the housing of the mobile radio apparatus 1B is limited as compared with the first antenna 11 and the second antenna 12 placed in end parts. However, the configuration in FIG. 3 is adopted, whereby the third antenna 13 does not become an ejector antenna and degradation of the antenna characteristic can be prevented while the design property is maintained.

Here, the antenna shape is letter L, but may be any other shape such as straight shape. Here, the length in the circuit board length direction is considered, but the length in the circuit board width direction may be considered. In this case, the antennas are concentrically placed in one end in the short length direction of the housing.

### Third Embodiment

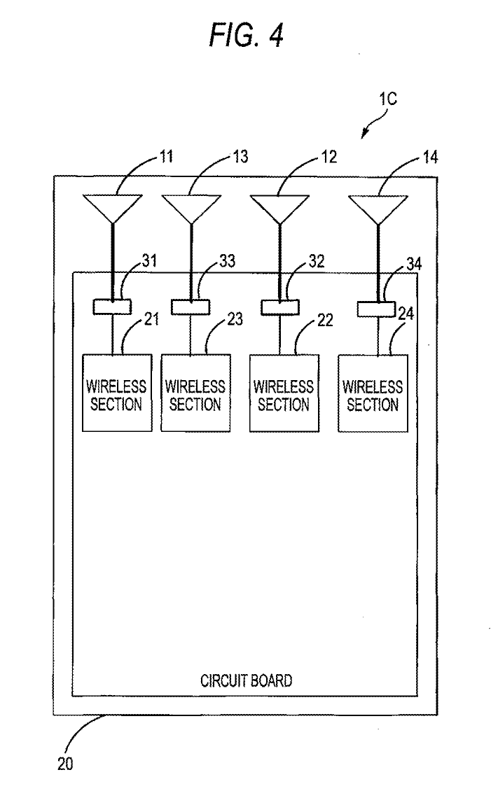

FIG. 4 is a block diagram to show a configuration example of a mobile radio apparatus in a third embodiment of the invention. A mobile radio apparatus 10 shown in FIG. 4 and the mobile radio apparatus 1 shown in the first embodiment differ in that the mobile radio apparatus 1C includes a fourth antenna 14, a fourth wireless section 24, and a fourth feeding section 34. Components of the mobile radio apparatus 1C identical with those of the mobile radio apparatus 1 are denoted by the same reference numerals and will not be discussed again or will be discussed briefly.

In the third embodiment, a second antenna 12 is used to transmit and receive a first radio wave for a cellular system and the operation frequency band is 830 MHz to 885 MHz.

The fourth antenna 14 is incorporated in a housing of the mobile radio apparatus 1C and is electrically connected to the fourth wireless section 24. For example, the fourth antenna 14 is used to transmit and receive a second radio wave for a cellular system and the operation frequency band is 2 GHz.

The fourth wireless section 24 performs necessary processing such as predetermined transmission and reception processing for a cellular wireless communication signal transmitted and received using the fourth antenna 14, thereby implementing a cellular wireless communication function. The operation frequency band is the same as that of the fourth antenna 14.

The fourth feeding section 34 is electrically connected to the fourth antenna 14 and the fourth wireless section 24 and feeds power mainly to the fourth antenna 14.

The fourth antenna 14 is an antenna element as a dipole antenna or a monopole antenna, for example. The fourth antenna 14 operates in a different operation frequency band from those of the antennas 11 to 13. However, the operation frequency band and the use of the fourth antenna 14 are an example and are not limited to them if a predetermined condition is satisfied.

Next, the placement relationship among the antennas 11 to 14 will be discussed.

The antennas 11 to 14 are placed in the same one end in the housing of the mobile radio apparatus 1C as with the mobile radio apparatus 1 of the first embodiment. Thus, the antennas 11 to 14 are concentrically placed in the same one end, whereby if the user grasps the mobile radio apparatus 1c, the antennas 11 to 14 are not covered with a hand and degradation of the antenna characteristic can be prevented. In the example shown in FIG. 4, the antenna shape is straight, but may be any other shape such as letter L.

In the mobile radio apparatus 1C of the embodiment, the fourth antenna 14 is placed on the opposite side to the third antenna 13 relative to the second antenna 12 or on the opposite side to the third antenna 13 relative to the first antenna 11 in one end in the housing. In the example shown in FIG. 4, the first antenna 11, the third antenna 13, the second antenna 12, and the fourth antenna 14 are placed in order from one end in the width direction of the housing (left end) to an opposite end in the width direction of the housing (right end) in one end in the length direction of the housing (upper end of housing). In addition to the placement shown in FIG. 4, the fourth antenna 14, the first antenna 11, the third antenna 13, and the second antenna 12 may be placed in order from the left end to the right end in the upper end of the housing. The arrangement of the antennas 11 to 14 may be opposite in the width direction of the housing (left and right opposite). In FIG. 4, the length direction of the circuit board is the up and down direction and the width direction of the circuit board is the left-right direction, but the width direction of the circuit board may be the up and down direction and the length direction of the circuit board may be the left-right direction. In this case, the antennas are concentrically placed in one end in the short length direction of the housing.

Next, the operation frequency bands of the antennas 11 to 14 will be discussed.

The embodiment assumes the following state for the operation frequency band in which the antenna 14 operates. The operation frequency bands of the antennas 11 to 13 are similar to those described in the first embodiment.
The fourth operation frequency band in which the fourth antenna 14 operates is not close to the first operation frequency band in which the first antenna 11 operates.
The fourth operation frequency band in which the fourth antenna 14 operates is not close to the second operation frequency band in which the second antenna 12 operates.
The fourth operation frequency band in which the fourth antenna 14 operates is close to the third operation frequency band in which the third antenna 13 operates.

That is, in the example in FIG. 4, one antenna whose operation frequency band is not close is inserted between the antennas whose operation frequency bands are close to each other.

Therefore, letting the first operation frequency band be fa, the second operation frequency band be fb, the third operation frequency band be fc, and the fourth operation frequency band be fd although not shown in the figure, (expression 1) to (expression 3) are satisfied and the following (expression 4) to (expression 6) are satisfied where fa<fb<fc<fd:

(fdmin−famax)/fdmin>0.2 (expression 4)

(fdmin−fbmax)/fdmin>0.2 (expression 5)

(fdmin−fcmax)/fdmin<0.2 (expression 6)

For example, when the first antenna 11 functions as a DTV antenna, the second antenna 12 functions as a cellular antenna, the third antenna 13 functions as a first GPS antenna, and the fourth antenna functions as a second cellular antenna, if the operation frequencies are applied to (expression 4) to (expression 6), the following results:
For (expression 4) (1940-770)11940 is near equal to 0.603
For (expression 5) (1940-885)/1940 is near equal to 0.544
For (expression 6) (1940-1575)/1940 is near equal to 0.188

Therefore, if the antennas 11 to 14 are arranged in one end as in the example, the operation frequency band of the first antenna 11 is close to the operation frequency band of the second antenna 12, the operation frequency band of the second antenna 12 is not close to the operation frequency band of the third antenna 13, the operation frequency band of the third antenna 13 is not close to the operation frequency band of the first antenna 11 as with the mobile radio apparatus 1 of the first embodiment. Further, the operation frequency band of the fourth antenna 14 is not close to the operation frequency band of the first antenna 12, the operation frequency band of the fourth antenna 14 is not close to the operation frequency band of the second antenna 12, and the operation frequency band of the fourth antenna 14 is close to the operation frequency band of the third antenna 13.

According to the mobile radio apparatus 1C of the embodiment, when four or more antennas are arranged in the same one end, the antennas whose operation frequency bands are close to each other (the first antenna 11 and the second antenna 12 and the third antenna 13 and the fourth antenna 14) are placed so that they are not adjacent, and the antennas whose operation frequency bands are not close to each other are placed so that they are adjacent, whereby electromagnetic coupling does not occur between the adjacent antennas. Therefore, if four or more antenna elements are included, degradation of the antenna characteristic can be prevented.

While the invention has been described in detail with reference to the specific embodiments, it will be obvious to those skilled in the art that various changes and modifications can be made without departing from the spirit and the scope of the invention.

This application is based on Japanese Patent Application No. 2008-329979 filed on Dec. 25, 2008, which is incorporated herein by reference.

### INDUSTRIAL APPLICABILITY

The invention is useful for a mobile radio apparatus, etc., that can prevent degradation of the antenna characteristic if three or more antenna elements are included.

### DESCRIPTION OF REFERENCE NUMERALS

1, 1B, 1C Mobile radio apparatus
11, 12, 13, 14 Antenna
21, 22, 23, 24 Wireless section
31, 32, 33, 34 Feeding section
101, 102, 103 Antenna

1. A mobile radio apparatus comprising:
a housing;
a circuit board provided in the housing; and
a first antenna element, a second antenna element, and a third antenna element that are placed in one end in the housing and operating in different operation frequency bands;
wherein the first antenna element operates in a first operation frequency band, wherein the second antenna element operates in a second frequency band that is close to the first operation frequency band, wherein the third antenna element operates in a third operation frequency band that is not close to the first operation frequency band or the second operation frequency band and is placed between the first antenna element and the second antenna element in the one end in the housing, and
wherein the distance between the end part and a third feeding section for feeding power to the third antenna element is longer than the distance between the one end and a first feeding section for feeding power to the first antenna element and is longer than the distance between the one end and a second feeding section for feeding power to the second antenna element.

2. The mobile radio apparatus as claimed in claim 1, wherein when two operation frequency bands are close to each other, the ratio of the difference between the lowest frequency in the higher band of the two operation frequency bands and the highest frequency in the lower band of the two operation frequency bands to the lowest frequency in the higher band of the two operation frequency bands is equal to or less than 0.2.

3. (canceled)

4. The mobile radio apparatus as claimed in claim 1, further comprising;
a fourth antenna element that is placed in the one end in the housing and operating in a different operation frequency band from those of the first antenna element, the second antenna element, and the third antenna element₄
wherein the fourth antenna element operates in a fourth operation frequency band close to the third operation frequency band and not close to the first operation frequency band or the second operation frequency band and is placed on the opposite side to the third antenna element relative to the second antenna element or on the opposite side to the third antenna element relative to the first antenna element in the one end in the housing.
